(19) United States
(12) Patent Application Publication
(10) Pub. No.: US 2006/0123595 A1
(43) Pub. Date: Jun. 15, 2006

(54) Hinge assembly with lubrication means

(75) Inventors: Chao Duan, Shenzhen (CN); Ying-Liang Tu, Shenzhen (CN); Mao-Fa Jiang, Shenzhen (CN); Qin Ou-Yang, Shenzhen (CN); Shun Guo, Shenzhen (CN); Chia-Hua Chen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH CO., LTD, Shindian City (TW)

(21) Appl. No.: 11/294,130

(22) Filed: Dec. 5, 2005

(30) Foreign Application Priority Data
Dec. 10, 2004 (CN) 200420102799.7

(51) Int. Cl. E05D 11/08

(52) U.S. Cl. 16/337

(57) ABSTRACT

A hinge assembly (10) includes a shaft (20), a follower (22), a cam (30), a washer (50), a lubrication mass forming means, and an urging means. The shaft has a securing portion (21) formed at one end thereof. The follower connects with the shaft. The cam essentially is in the shape of a cylinder, and includes a cam surface (32) and defines a cam hole (31) extending therethrough. The cam hole receives the shaft therethrough. The washer defines a center hole (52), and is located around the shaft. The lubrication mass forming means is disposed between the washer and the cam. One end of the urging means abuts the shaft, and an opposite end of the urging means biases the washer. The cam surface of the cam is rotatably and movably engaged with the follower under force of the urging means.

### FIELD OF THE INVENTION

The present invention relates to hinge assemblies, and particularly to a hinge assembly for foldable electronic devices such as mobile telephones, electronic notebooks, and so on.

### GENERAL BACKGROUND

With the development of the technologies of wireless communication and information processing, portable electronic devices such as mobile telephones and electronic notebooks are now in widespread use. These electronic devices enable consumers to enjoy the convenience of high technology services anytime and anywhere. Foldable electronic devices are particularly favored by consumers for their convenience.

Generally, foldable electronic devices have most of the electronics in one housing, called the main body. The other housing, called the cover, typically contains fewer electronic components than the main body. Other foldable electronic devices have all the electronics in the main body, with the cover containing no electronics. Various types of hinge assemblies are used to join a main body and a cover of a foldable electronic device, so that the cover can unfold up from and fold down upon the main body. Manufacturers are constantly seeking to reduce the volume, size and weight of portable foldable electronic devices. Thus, it is desirable that the hinge assembly coupling the main housing with the cover is modularized and miniaturized. A modularized hinge assembly has moving parts such as a cam member, a follower, and a spring held together in a unified structure. The structure is easily and quickly attached to the main body and the cover during mass production. A miniaturized hinge assembly has as few parts as possible, with the parts being as small as practicable.

One kind of conventional foldable electronic device with a hinge assembly is configured as follows. The foldable electronic device is typically a mobile phone. The hinge assembly includes a housing secured to a main body of the mobile phone, a spring received in the housing, a rotary cam rod, and a shaft with a follower and a connecting portion. The rotary cam rod is received in the housing and engages with the housing. One end of the spring contacts an inner wall of the housing, and the other end of the spring resists one end of the rotary cam rod. The shaft is passed through the rotary cam rod and the spring in that order.

Although the above-described hinge assembly is suitable for some foldable electronic devices, the spring and the rotary cam rod are in direct contact with each other. Dry friction is produced between the spring and the rotary cam rod because of relative rotation therebetween. This wastes energy and causes abrasion of the spring and the rotary cam rod. The abrasion may eventually lead to premature malfunction or failure of the hinge assembly.

What is needed, therefore, is a hinge assembly which can have a relatively long working lifetime and which is energy efficient and convenient to use.

### SUMMARY

In a first preferred embodiment, a hinge assembly is provided for joining a cover to a main body of a foldable electronic device. The hinge assembly includes a shaft, a follower, a cam, a washer, a lubrication mass forming means, and an urging means. The shaft has a securing portion formed at a first end thereof, for connecting to the main body of the foldable electronic device. Preferably, the follower is integrally connected with the shaft. The cam is essentially in the shape of a cylinder, and is for connecting to the cover of the foldable electronic device. The cam includes a cam surface, and defines a cam hole extending therethrough. The cam hole receives the shaft therethrough. The washer defines a center hole, and is located around the shaft. The lubrication mass forming means is disposed between the washer and the cam. A first end of the urging means abuts the shaft, and an opposite second end of the urging means biases the washer. The cam surface of the cam is rotatably and movably engaged with the follower under force of the urging means.

A main advantage of the above-described hinge assembly is that the lubrication mass forming means is disposed between the cam and the washer. The lubrication mass forming means is rotated in unison with the cam, and rotates relative to the washer. Thereby, a mass of lubrication is formed between the lubrication mass forming means and the washer when the cam is rotated relative to the washer. This reduces friction between the cam and the washer. Accordingly, when the hinge assembly is assembled in a mobile phone, the energy required in opening the cover of the mobile phone is reduced. Furthermore, the working lifetime of the hinge assembly is prolonged.

In a second preferred embodiment, a hinge assembly is provided for joining a cover to a main body of a foldable electronic device. The hinge assembly includes a shaft, a follower, a cam, a washer, a lubrication mass forming means, and an urging means. The shaft has a securing portion formed at a first end thereof, and a latching portion formed at an opposite second end thereof. The securing portion is for connecting to the cover of the foldable electronic device. Preferably, the follower is integrally connected with the shaft. The cam is essentially in the shape of a cylinder, and is for connecting to the main body of the foldable electronic device. The cam includes a cam surface, and defines a cam hole extending therethrough. The cam hole receives the shaft therethrough. The washer defines a center hole, and is located around the shaft. The lubrication mass forming means is disposed between the washer and the latching portion of the shaft. A first end of the urging means abuts the washer, and an opposite second end of the urging means biases the cam. The follower is rotatably and movably engaged with the cam surface of the cam under force of the urging means.

A main advantage of the above-described hinge assembly is that the lubrication mass forming means is disposed between the washer and the latching portion of the shaft. The lubrication mass forming means is rotated in unison with the latching portion, and rotates relative to the washer. Therefore a mass of lubrication is formed between the lubrication mass forming means and the washer when the latching portion is rotated relative to the washer. This reduces friction between the washer and the latching portion. Accordingly, when the hinge assembly is assembled in a mobile phone, the energy required in opening the cover of the mobile phone is reduced. Furthermore, the working lifetime of the hinge assembly is prolonged.

Other advantages and novel features will become more apparent from the following detailed description when taken in conjunction with the accompanying drawings, in which:

### BRIEF DESCRIPTION OF THE DRAWINGS

FIG. 1 is an isometric view of a flip type mobile phone including a cover, a main body, and a hinge assembly according to a first preferred embodiment of the present invention, the hinge assembly being shown with dashed lines;

FIG. 2 is an enlarged, exploded, isometric view of the hinge assembly of FIG. 1;

FIG. 3 is similar to FIG. 2, but viewed from another aspect;

FIG. 4 is an enlarged, assembled view of the hinge assembly of FIG. 1;

FIG. 5 is similar to FIG. 4, but showing the hinge assembly in another state;

FIG. 6 is an enlarged, schematic, side view of part of the hinge assembly shown in FIG. 2, showing a pushing block thereof in a parallel position;

FIG. 7 is similar to FIG. 6, but showing the pushing block in an inclined position; and

FIG. 8 is an exploded, isometric view of a hinge assembly according to a second preferred embodiment of the present invention.

### DETAILED DESCRIPTION OF PREFERRED EMBODIMENTS

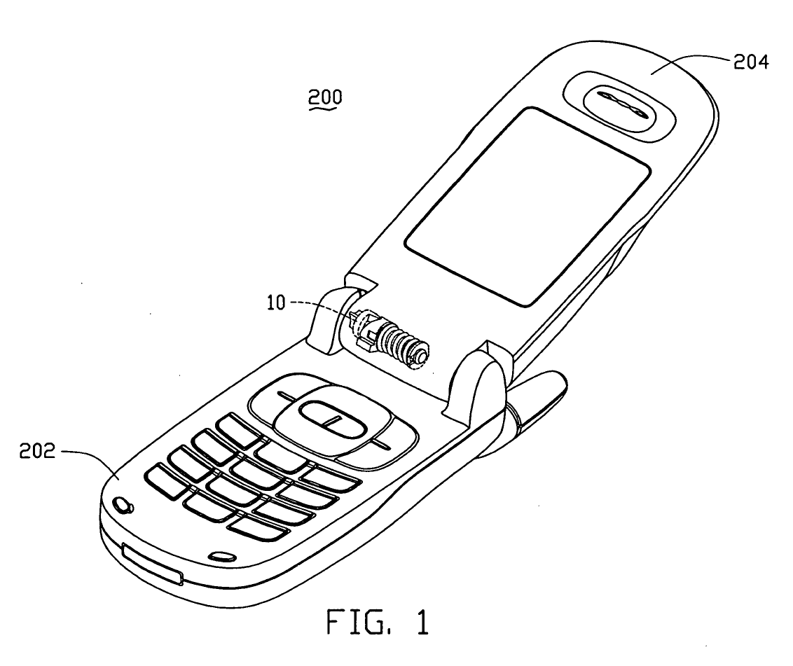

Referring now to the drawings, FIG. 1 shows an electronic device like a flip type mobile phone 200, which includes a hinge assembly 10 according to a first preferred embodiment of the present invention. The mobile phone 200 has a main body 202 and a cover 204. The main body 202 and the cover 204 are pivotally connected to each other via the hinge assembly 10. It should be noted that the hinge assembly 10 is also able to be used to interconnect components like a main body and a cover of any of various different kinds of foldable electronic devices other than the mobile phone 200.

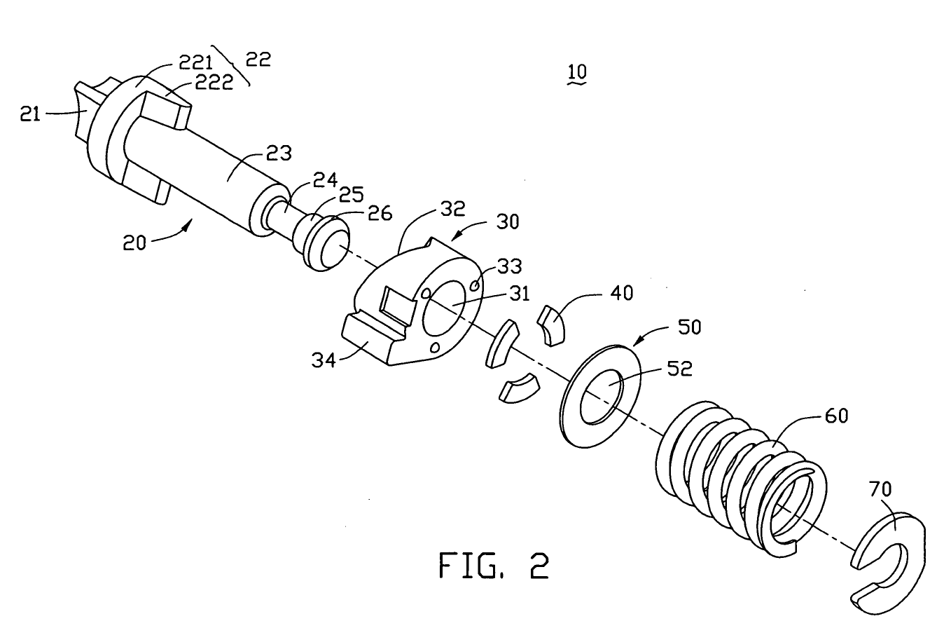

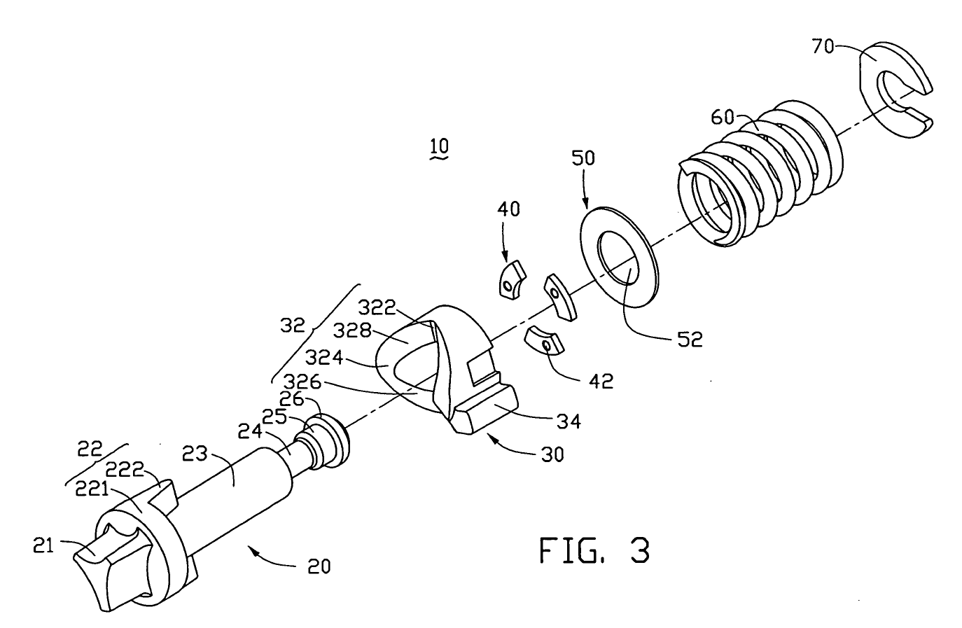

Referring now to FIGS. 2 and 3, the hinge assembly 10 includes a shaft 20, a cam 30, a plurality of pushing blocks 40, a washer 50, a spring 60 functioning as an elastic urging means, and a clip 70. In the illustrated embodiment, there are three pushing blocks 40. The shaft 20 extends through the cam 30, the washer 50, the spring 60, and the clip 70, thereby integrating the hinge assembly 10.

The shaft 20 includes in sequence a securing portion 21 formed at a first end thereof, a follower 22 adjacent the securing portion 21, a large diameter portion 23, a neck portion 24, and a small diameter portion 25. The securing portion 21 is for engaging with the main body 202 of the mobile phone 200. The follower 22 includes an enlarged cylindrical portion 221, and two symmetrically opposite finger portions 222 extending in an axial direction and adjoining one end of the large diameter portion 23. The small diameter portion 25 has a latching portion 26 formed at one end thereof. A diameter of the latching portion 26 is larger than that of the small diameter portion 25.

The cam 30 is a generally cylindrical body and defines a cam hole 31. The cam 30 has a cam surface 32 formed at a first end thereof, and a plurality of hemispherical bulges 33 formed on an opposite second end thereof. In the illustrated embodiment, there are three bulges 33. The bulges 33 are symmetrically spaced apart from each other around the cam hole 31. The bulges 33 can alternatively be partially hemispherical, arc-shaped relative to a central axis of the cam 30, substantially semicircular relative to the central axis of the cam 30, or have another suitable shape. Further, the bulges 33 can alternatively be a single substantially semicircular bulge, a single substantially circular bulge, or a single bulge having another suitable shape. The cam surface 32 includes two valleys 322, two peaks 324, two moderate inclined planes 326, and two steep inclined planes 328. Preferably, the valleys 322 are located 180 degrees opposite from each other, and the peaks 324 are located 180 degrees opposite from each other. The cam 30 has a protrusion 34 formed on an outer peripheral wall thereof, the protrusion 34 being oriented parallel to the central axis of the cam 30. The protrusion 34 is for engaging with the cover 204 of the mobile phone 200.

The pushing blocks 40 are arc-shaped, and together form part of a same imaginary ring. Each pushing block 40 defines a generally hemispherical but eccentric concavity 42 in a first surface portion thereof. The bulges 33 of the cam 30 can movably engage in the concavities 42 of the pushing blocks 40. An opposite second surface of each pushing block 40 resists the washer 50. Further, the concavities 42 can alternatively have other shapes and configurations, corresponding to the above-described alternative shapes and configurations of the bulges 33.

The washer 50 is circular and defines a center hole 52. A first main surface of the washer 50 resists the second surface of the pushing blocks 40, and an opposite second main surface of the washer 50 resists the spring 60.

The spring 60 is helical and preferably metallic, with an inner diameter larger than a diameter of the large diameter portion 23 of the shaft 20. Thus the spring 60 can be located around the shaft 20. A second end of the spring 60 resists the second main surface of the washer 50, and an opposite first end of the spring 60 resists the clip 70.

The clip 70 is C-shaped, and is made of an elastic material. A first main surface of the clip 70 resists the spring 60, an opposite second main surface of the clip 70 resists the latching portion 26 of the shaft 20.

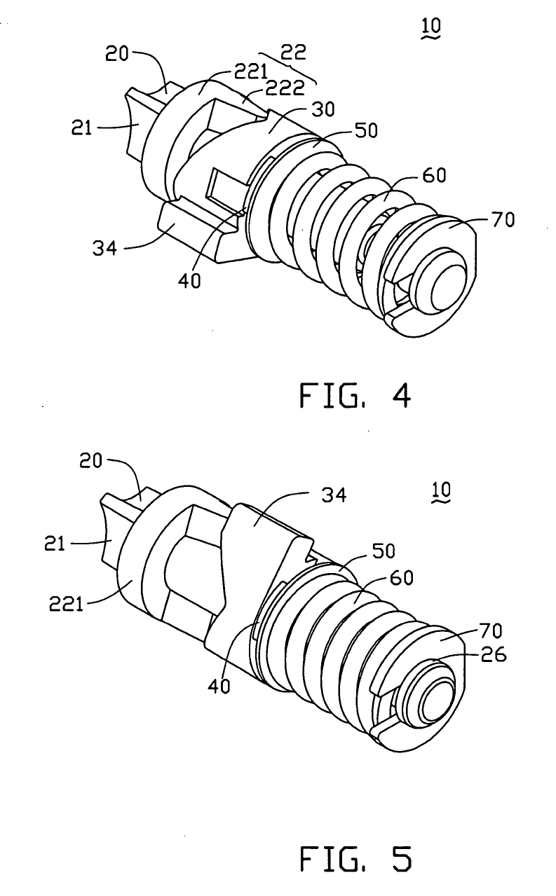

Referring to FIGS. 4 and 5, in assembly of the hinge assembly 10, firstly, the shaft 20 is passed through the cam hole 31 of the cam 30, the center hole 52 of the washer 50, and the spring 60 in that order. The pushing blocks 40 are received between the cam 30 and washer 50. The clip 70 is snappingly engaged around the small diameter portion 25 of the shaft 20, such that the spring 60 is slightly compressed. The bulges 33 of the cam 30 movably engage in the concavities 42 of the pushing blocks 40, and the second surfaces of the pushing blocks 40 abut against the first main surface of the washer 50 under force of the spring 60. The second main surface of the washer 50 resists the second end of spring 60. The first end of the spring 60 resists the first surface of the clip 70. The latching portion 26 of the shaft 20 resists the second surface of the clip 70, and prevents the clip 70 from falling off from the shaft 20. The cam surface 32 of the cam 30 always contacts the finger portions 222 no matter what rotational position the cam 30 is in, because of urging force of the spring 60. The hinge assembly 10 is thus completely assembled. Finally, lubricant is applied generally between the pushing blocks 40 and the second end of the cam 30, and between the pushing blocks 40 and the first main surface of the washer 50. The lubricant may for example be lubricating oil. The hinge assembly 10 is thus completely assembled.

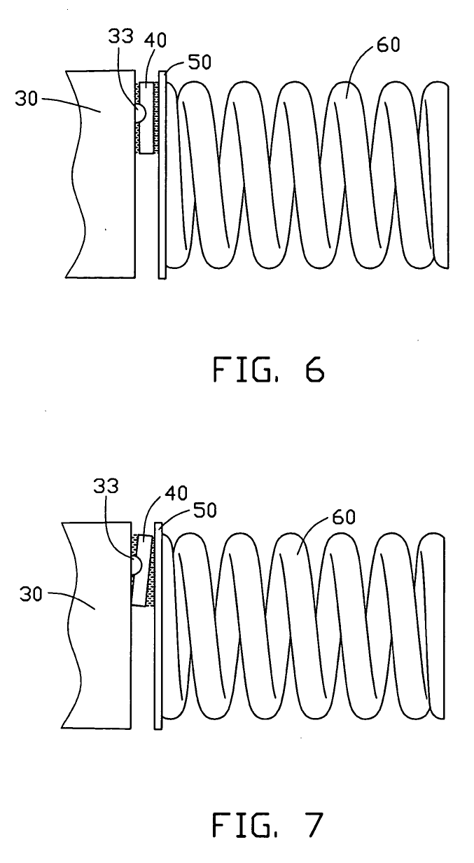

Referring also to FIG. 6, in use, the protrusion 34 is engaged in a cavity (not shown) of the cover 204 of the mobile phone 200, and the securing portion 21 of the shaft 20 is engaged in the main body 202 of the mobile phone 200. When the cover 204 of the mobile phone 200 is in a fully open position (or fully closed position), the finger portions 222 of the shaft 20 are located in the valleys 322 of the cam 30 and engage with the valleys 322. The pushing blocks 40 may initially be oriented generally parallel to both the second end of the cam 30 and the washer 50.

Referring also to FIG. 7, when the cover 204 of the mobile phone 200 is rotated between an open position and a closed position (or vice versa), the cam 30 rotates along with the cover 204, while the shaft 20 remains fixed in the main body 202 of the mobile phone 200. As a result, the finger portions 222 ride along the moderate inclined planes 326 of the cam surface 32 from the valleys 322 to the peaks 324, with the cam 30 moving toward the clip 70 and compressing the spring 60. At the same time, the pushing blocks 40 rotate in unison with the cam 30, and thereby rotate relative to the washer 50. The cam 30 and the washer 50 resist each other via the pushing blocks 40, and the bulges 33 of the cam 30 engagingly receive the concavities 42 of the pushing blocks 40. When the spring 60 is compressed as described above, corresponding same ends of the pushing blocks 40 are inclined toward the washer 50 by the applied force because of the eccentric configurations of the concavities 42. Thus the lubricant between the pushing blocks 40 and the washer 50 is reformed into a generally cuneiform mass. This reduces friction between the pushing blocks 40 and the washer 50, and thus reduces friction between the cam 30 and the washer 50. Once the finger portions 222 pass over the peaks 324, the spring 60 decompresses and drives the cam 30 back toward the cylindrical portion 221, with the finger portions 222 riding along the steep inclined planes 328 from the peaks 324 to the valleys 322. When the spring 60 decompresses as described above, said ends of the pushing blocks 40 are inclined toward the cam 30 by the expansion force exerted by the spring 60 and because of the eccentric configurations of the concavities 42. Thus the lubricant between the pushing blocks 40 and the washer 50 is reformed into another generally cuneiform mass. This reduces friction between the pushing blocks 40 and the washer 50, and thus reduces friction between the cam 30 and the washer 50. According to the above-described process, the cover 204 is rotated automatically to the fully open position (or fully closed position) under the decompression force of the spring 60. That is, the cover 204 is moved 180 degrees relative to the main body 202, with the finger portions 222 once again mating in the valleys 322. In this way, the cover 204 is opened (or closed). Preferably, the structures of the cover 204 and the main body 202 are adapted to control the degree of rotation of the hinge assembly 10, such that the finger portions 222 can be held in one or more particular locations between the valleys 322 and the peaks 324.

In further alternative embodiments, the follower 22 can be a separate element that is not integrally formed with the shaft 20. In such case, the follower 22 defines a shaft hole, and has a cam surface or finger portions. The cam 30 can define a plurality of concavities, and the pushing blocks 40 can form a plurality of bulges. The spring 60 can be made of nonmetallic material such as plastic. Further, the spring 60 can instead be another kind of elastic element or urging means known in the art, such as a resilient cylinder. The clip 70 can be omitted, in which case the spring 60 directly resists the latching portion 26. There can be more than one protrusion 34.

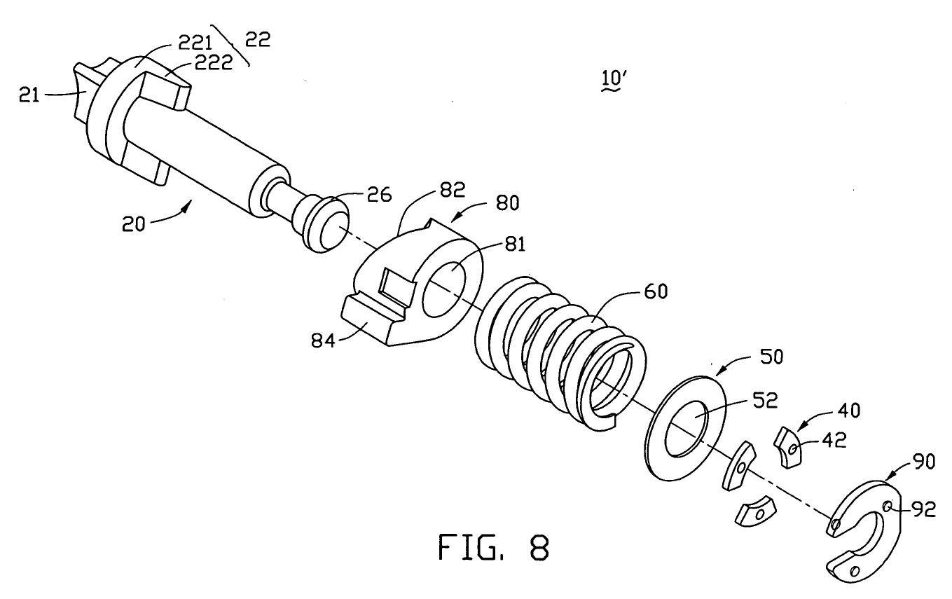

Referring to FIG. 8, a hinge assembly 10′ according to a second preferred embodiment of the present invention is similar to the hinge assembly 10, except that the hinge assembly 10′ has a cam 80 and a clip 90. The cam 80 has a cam surface 82 formed at one end thereof. One surface of the clip 90 facing the spring 60 has a plurality of hemispherical bulges 92 formed thereon. In the illustrated embodiment, there are three bulges 92. The hinge assembly 10′ can be used to pivotally connect the main body 202 and the cover 204 of the mobile phone 200. However, the securing portion 21 of the shaft 20 is used to connect with the cover 204, and a protrusion 84 of the cam 80 is used to connect with the main body 202. In such case, there is no relative rotation between the cam 80 and the spring 60, whereas there is relative rotation between the clip 90 around the shaft 20 and the spring 60. Accordingly, the washer 50 and pushing blocks 40 are disposed between the spring 60 and the clip 90. Lubricant between the pushing blocks 40 and the washer 50 can be reformed into a generally cuneiform mass, in much the same way as described above in relation to the hinge assembly 10 of the first preferred embodiment. This reduces friction between the pushing blocks 40 and the washer 50, and thus reduces friction between the clip 90 and the washer 50.

In an alternative embodiment, the clip 90 can be omitted. In such case, the washer 50 and the pushing blocks 40 are disposed between the spring 60 and the latching portion 26 of the shaft 20. The hinge assembly 10′ may have other alternative embodiments, similar to the alternative embodiments described above in relation to the hinge assembly 10.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A hinge assembly for joining a cover to a main body of a foldable electronic device, comprising:
a shaft comprising a securing portion formed at a first end thereof;
a follower connecting with the shaft;
a cam essentially in the shape of a cylinder, comprising a cam surface and defining a cam hole extending therethrough, the cam hole receiving the shaft therethrough;
a washer defining a hole and being located around the shaft;
a lubrication mass forming means disposed between the washer and the cam; and
an urging means, a first end of the urging means abutting the shaft, an opposite second end of the urging means biasing the washer, the cam surface of the cam being rotatably and movably engaged with the follower under force of the urging means.

2. The hinge assembly as claimed in claim 1, wherein the lubrication mass forming means comprises a plurality of pushing blocks movably engaged between the cam and the washer.

3. The hinge assembly as claimed in claim 2, wherein each pushing block defines an eccentric concavity in a first surface portion thereof.

4. The hinge assembly as claimed in claim 3, wherein a surface of the cam opposite to the pushing blocks comprises a plurality of bulges movably engaged in the concavities of the pushing blocks.

5. The hinge assembly as claimed in claim 4, wherein the concavities are generally hemispherical, and the bulges are generally hemispherical.

6. The hinge assembly as claimed in claim 1, wherein the follower and the shaft are integrally formed, the follower is adjacent the securing portion and comprises two finger portions, and the cam surface of the cam is rotatably and movably engaged with the finger portions.

7. The hinge assembly as claimed in claim 1, wherein the shaft further comprises a clip, and the urging means abuts the clip.

8. The hinge assembly as claimed in claim 1, wherein the urging means is a helical spring located around the shaft.

9. The hinge assembly as claimed in claim 1, wherein the cam surface has a pair of opposite valleys and a pair of opposite peaks.

10. The hinge assembly as claimed in claim 1, wherein the shaft further comprises a latching portion formed at an opposite second end thereof, and the urging means abuts the latching portion.

11. A hinge assembly for joining a cover to a main body of a foldable electronic device, comprising:
a shaft comprising a securing portion formed at a first end thereof, and a latching portion formed at an opposite second end thereof;
a follower connecting with the shaft;
a cam essentially in the shape of a cylinder, comprising a cam surface and defining a cam hole extending therethrough, the cam hole receiving the shaft therethrough;
a washer defining a hole and being located around the shaft;
a lubrication mass forming means disposed between the washer and the latching portion of the shaft; and
an urging means, a first end of the urging means abutting the washer, an opposite second end of the urging means biasing the cam, the follower being rotatably and movably engaged with the cam surface of the cam under force of the urging means.

12. The hinge assembly as claimed in claim 11, wherein the lubrication mass forming means comprises a plurality of pushing blocks movably engaged between the washer and the latching portion of the shaft.

13. The hinge assembly as claimed in claim 12, wherein each pushing block defines an eccentric concavity in a first surface portion thereof.

14. The hinge assembly as claimed in claim 13, wherein a surface portion of the latching portion opposite to the pushing blocks comprises a plurality of bulges movably engaged in the concavities of the pushing blocks.

15. The hinge assembly as claimed in claim 14, wherein the concavities are generally hemispherical, and the bulges are generally hemispherical.

16. The hinge assembly as claimed in claim 11, wherein the follower and the shaft are integrally formed, the follower is adjacent the securing portion and comprises two finger portions, and the finger portions are rotatably and movably engaged with the cam surface of the cam.

17. The hinge assembly as claimed in claim 11, wherein the urging means is a helical spring located around the shaft.

18. An electronic device comprising:
a main body of said electronic device;
a cover of said electronic device capable of abutting against a side of said main body to cover said side and movable relative to said main body away from said side to expose said side; and
a hinge assembly disposed between said main body and said cover to controllably conduct movement of said cover relative to said main body, said hinge assembly comprising at least two relatively movable components movably interengagable with each other so as to conduct said movement of said cover, and an urging means capable of abutting against at least one of said at least two movable components in order for contributing to movement-conducting of said at least two movable components, a lubrication means located between said urging means and said at least one of said at least two movable components, and capable of providing lubrication effect between said urging means and said at least one of said at least two movable components due to relative movement of said at least two movable components.

19. The electronic device as claimed in claim 18, wherein said lubrication means comprises a plurality of pushing blocks movably engagable between said urging means and said at least one of said at least two movable components.
